(19) United States
(12) Patent Application Publication
(10) Pub. No.: US 2015/0153185 A1
(43) Pub. Date: Jun. 4, 2015

(54) METHOD FOR INTERWORKING BETWEEN NAVIGATION TERMINALS

(71) Applicant: HYUNDAI MOTOR COMPANY, Seoul (KR)

(72) Inventor: Kwang Hun CHOI, Suwon-si (KR)

(21) Appl. No.: 14/472,189

(22) Filed: Aug. 28, 2014

(30) Foreign Application Priority Data
Dec. 2, 2013 (KR) 10-2013-0148414

(51) Int. Cl. G01C 21/26

(52) U.S. Cl. CPC G01C 21/26

(57) ABSTRACT

A method for interworking between navigation terminals includes switching a used terminal in such a way that another terminal communication-connected with the used terminal receives information necessary to execute a navigation service to perform a navigation service function when the used terminal, which provides the navigation service mounted in the vehicle, does not search a destination or does not execute the navigation service in a case where the terminals are mounted in the vehicle.

### CROSS-REFERENCE TO RELATED APPLICATION

This application claims under 35 U.S.C. §119(a) the benefit of priority to Korean Patent Application No. 10-2013-0148414, filed on Dec. 3, 2013, the entire contents of which are incorporated herein by reference.

### TECHNICAL FIELD

The present disclosure relates to a route guiding method, and more particularly, to a method for interworking between a plurality of navigation terminals in order to guide a route in a vehicle.

### BACKGROUND

In these days, a multi-media technology for vehicles, such as an information transfer technology, has been developed to provide comfortable and convenient infotainment to a driver. Such a technology requires the driver to operate more devices during driving due to complexity of a vehicle and various running patterns. In addition, a large amount of information, such as voice, data, image, and graphic information, is required from inside and outside of the vehicle.

Accordingly, various gadgets, safety devices, and running assist devices are mounted in the vehicle. For example, the various gadgets may include an audio/video system for the vehicle and a navigation system to provide map information and traffic information. Recently, an audio video and navigation (AVN) system with an integrally configured audio system, video system, and navigation system is provided with the vehicle.

Generally, an onboard navigation terminal mounted in the vehicle provides a navigation service, for example, software associated with map data is stored in a memory in the AVN system of the vehicle. A map and a running route are displayed on a display included in a head unit during route guidance. Further, a portable terminal in which a related application is installed, that is, a smart device such as a smart phone or a tablet PC, is available as for another method capable of using the navigation service (including a route guide service) in the vehicle.

There are advantages and disadvantages of using the smart device which provides the navigation service separately from the onboard navigation service. The navigation terminal mounted in the vehicle provides the map and the running route through a relatively large screen (a display device screen of the head unit). Moreover, the navigation terminal can provide an optimal function and a stable service to the vehicle.

However, the navigation terminal does not provide real time traffic information, and there are limitations to provide an amount of contents and a network based service.

On the other hand, the navigation service of the smart device may generate and display a running route by reflecting the real time traffic information provided from a server outside the vehicle. The smart device may provide various contents and various network based services as compared with the navigation terminal in the vehicle.

In addition, when the navigation service of the portable terminal such as the smart device is the onboard terminal which is driven based on data stored in a navigation server outside the vehicle, it is not necessary to store a large amount of the map or data since the map, data, and software to be used may be continuously updated regardless of the terminal. However, a relatively small screen of the terminal is used, and since an offboard terminal continuously access the navigation server outside the vehicle to connect with a network, a service drive time is relatively slow.

In this manner, since the portable terminal such as the navigation terminal mounted in the vehicle and the smart device has some advantages and disadvantages, the portable terminal is expected to be developed so that the user is able to select the one he/she prefers.

However, although the user can use the navigation terminal, the portable terminal, the onboard terminal, and the offboard terminal in the vehicle, the user inconveniently needs to operate two terminals independently. For example, as shown in FIG. 1, when there is no information available in the onboard terminal, in order to use the offboard terminal, the offboard terminal may search the information after the onboard terminal is terminated, and a destination is reentered using the offboard terminal.

FIG. 2 shows a case where the onboard terminal is used when there is a problem such as a network issue with the offboard terminal. In this case, after the offboard terminal is terminated in a state that route guidance is provided from the offboard terminal during driving, the route may guide a user only if the user reenters and searches a destination in the onboard terminal.

As described above, since the user receives the route guidance after newly searching the destination by turning-off the terminal and operating another terminal while driving, operating the terminals is significantly complicated and reduces safe driving.

### SUMMARY OF THE DISCLOSURE

The present disclosure has been made in an effort to solve the above-described problems associated with prior art. The present disclosure provides a method for interworking between navigation terminals which may provide a stable navigation service through an interwork function between the navigation terminals in an environment where a user can use a plurality of navigation terminals in a vehicle and may continuously switch and navigate between the terminals without an additional setting and user operation.

The present disclosure further provides a method for interworking between navigation terminals capable of providing a desired navigation service to a driver by operating respective terminals through interworking and switch functions between the terminals.

In accordance with an exemplary embodiment of the present disclosure, a method for interworking between navigation terminals is provided. The method includes switching a used terminal switch in such a way that another terminal communication-connected with the used terminal receives information necessary to execute a navigation service to perform a navigation service function when the used terminal, which provides the navigation service mounted in a vehicle, does not search a destination or does not execute the navigation service in a case where the terminals are mounted in the vehicle.

The terminals may include a navigation terminal mounted in the vehicle and a portable terminal in which a navigation application is installed.

Display information of the portable terminal may be displayed on the navigation terminal mounted in the vehicle which is communication-connected with the portable terminal when the navigation service is executed.

The terminals may include an onboard terminal to provide the navigation service in an onboard scheme and an offboard terminal to provide the navigation service in an offboard scheme.

When a failure in network communication with a navigation server outside the vehicle occurs during use of the offboard terminal, the used terminal may switched in such a way that the offboard terminal transfers information necessary to execute the navigation service to the onboard terminal so that the onboard terminal performs the navigation service function.

The terminal switch may be achieved in such a way that the other terminal, which is communication-connected, receives the information to execute the navigation service to perform the navigation service function when the used terminal is switched by a user p.

The terminal, which does not search a destination or does not execute the navigation service, may request execution of the navigation service to the other terminal to transfer the information necessary to execute the navigation service to the other terminal.

The information necessary to execute the navigation service may include destination information to guide a running route and the used terminal, which performs the navigation service function after the terminal switch, automatically searches and sets the destination. The terminal further generates and guides the running route using the destination information.

Therefore, according to embodiments of the present disclosure, a stable navigation service can be used through interworking and switch functions between terminals, and automatic switching and a continuous navigation between the terminals can be used without additional setting and operation of the user.

The present disclosure further provide a desired navigation service having excellent quality of a driver in the vehicle while using only advantages of respective terminals through interworking and switch functions between the terminals to the highest degree.

In addition, since additional setting and operation of the user can be minimized during use of the terminals, and an unnecessary operation can be prevented, safe running can be improved.

### BRIEF DESCRIPTION OF THE DRAWINGS

The above and other features of the present disclosure will now be described in detail with reference to certain exemplary embodiments thereof illustrated by the accompanying drawings which are given hereinafter by way of illustration only, and thus are not limitative of the present disclosure.

FIGS. 1 and 2 are flowcharts illustrating problems of the related art.

FIG. 3 is a diagram illustrating a configuration of a terminal system for performing an interworking procedure according to an embodiment of the present disclosure.

FIGS. 4 and 5 are flowcharts illustrating a method for interworking between navigation terminals according to an embodiment of the present disclosure.

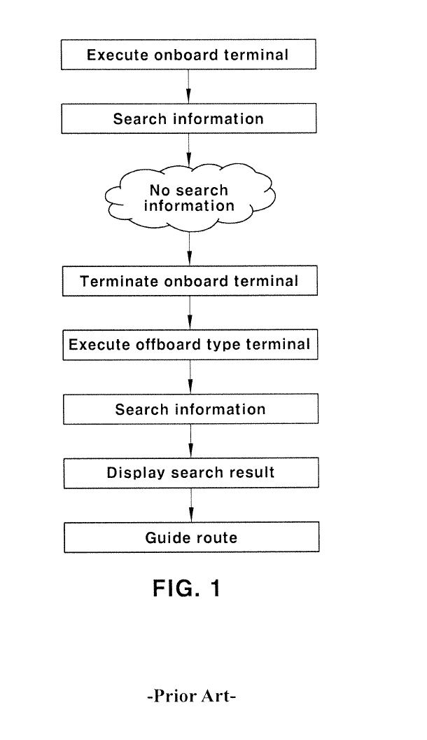

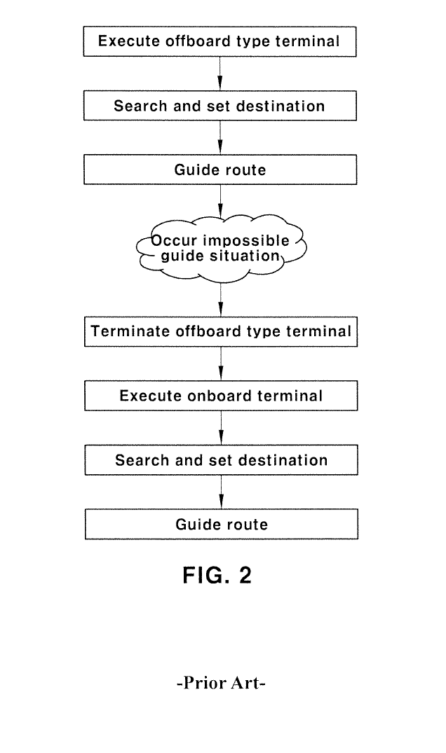

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION

Hereinafter, an exemplary embodiment of the present disclosure will be described more specifically with reference to the accompanying drawings.

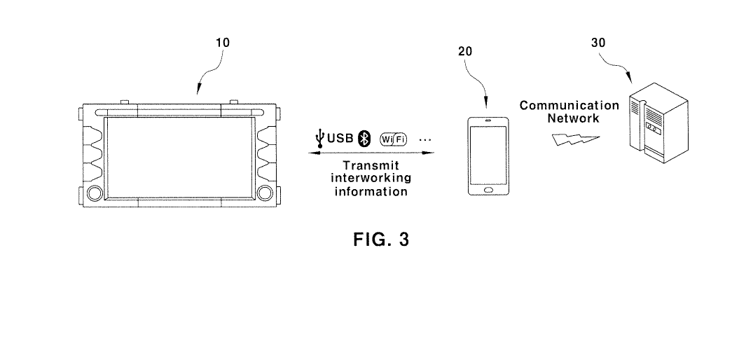

FIG. 3 is a diagram illustrating a configuration of a terminal system for performing an interworking procedure according to an embodiment of the present disclosure.

The present disclosure relates to a method for interworking between a plurality of terminals to guide a route in a vehicle. According to the present disclosure, when a plurality of terminals 10 and 20, which provide a navigation service, are mounted in the vehicle, and one of a plurality of terminals 10 and 20 does not search a destination or does execute the navigation service, the other terminal communication-connected with a used terminal receives information necessary to execute a navigation service to perform a navigation service function.

One of the terminals 10 and 20 may include a navigation terminal, for example, an audio video navigation (AVN) system in the vehicle, and remaining one thereof may include a portable terminal, for example, a smart device such as a smart phone or a tablet PC in which a navigation application is installed. One of the terminals 10 and 20 may be an onboard terminal to provide the navigation service in an onboard scheme, and remaining one thereof may be an offboard terminal to provide the navigation service in an offboard scheme.

In general, since the navigation terminal mounted in the vehicle is the onboard terminal, when the terminals are classified into the onboard terminal and the offboard terminal, the navigation terminal mounted in the vehicle is the onboard terminal, and the portable terminal is the offboard terminal.

The plurality of terminals 10 and 20 included in the vehicle, for example, both of the navigation portable terminals may be the onboard navigation terminal. Further, the terminals 10 and 20 included in the vehicle may be a buried terminal (or the AVN system) and a vehicle mount terminal. According to the present disclosure, the terminals 10 and 20 are connected to each other in a wired scheme or a wireless scheme to exchange information with each other.

Hereinafter, a navigation terminal mounted in a vehicle and a smart device having a navigation function according to an embodiment of the present disclosure will be described by way of example.

In the following description, the navigation terminal (or onboard terminal) is referred to as ‘a first terminal’, and a smart device (or offboard type terminal) is referred to as ‘a second terminal’.

A first terminal 10 included in the vehicle and a second terminal 20 may be connected to each other through wired communication or wireless communication. The first terminal 10 and the second terminal 20 may exchange information necessary to execute the navigation service with each other through the wired communication or the wireless communication. For example, an applicable interface of the wired or wireless communication near field network may include Bluetooth, WiFi, NFC, USB, Digital iPod-Out, HDMI, and MHL.

In order to use navigation of the first terminal 10 mounted in the vehicle, if a running route is generated after the first terminal 10 searches and sets a destination, a route guide to display a route on a map on a display device of the first terminal 10 is achieved while the vehicle is running. When navigating by the second terminal 20, since the second terminal 20 is communication-connected to the first terminal 10, information displayed on a screen of the second terminal 20 is also displayed on the display device of the first terminal 10. That is, if the running route is generated after the second terminal 20 searches and sets the destination, a route guide (providing navigation information) displayed on the second terminal 20 screen is also achieved through the display device of the first terminal 10.

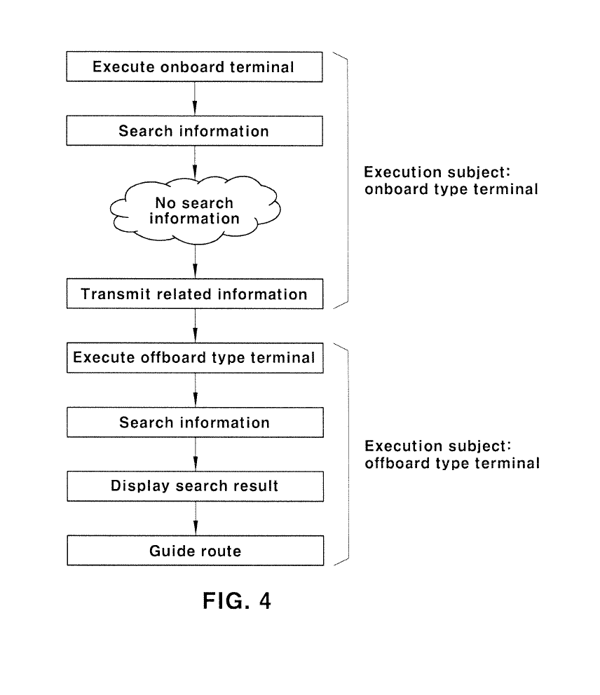

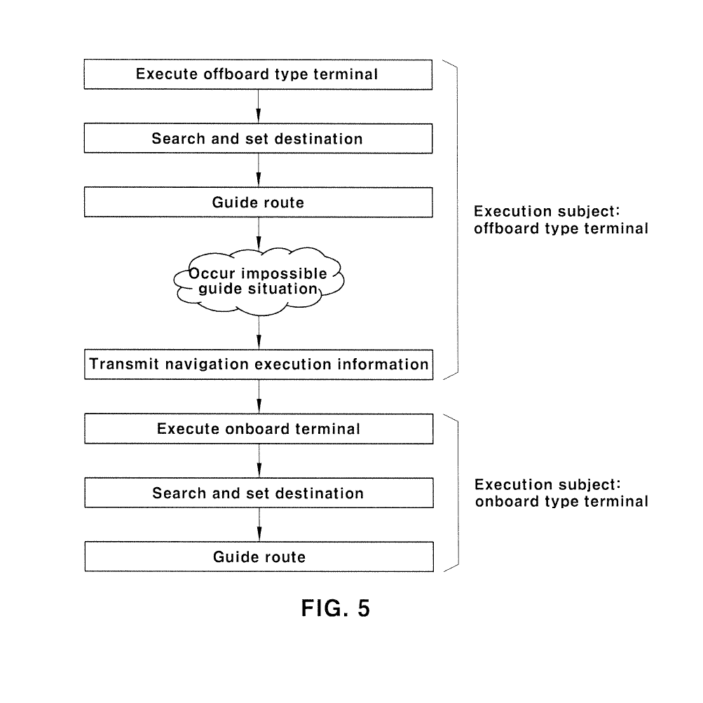

FIGS. 4 and 5 are flowcharts illustrating a method for interworking between navigation terminals according to an embodiment of the present disclosure. In the method for interworking between navigation terminals according to an embodiment of the present disclosure, when one of the first and second terminals 10 and 20, that is a used terminal, cannot find a destination or cannot execute a navigation service requested by a driver, information according to an operation input of the driver is transmitted to a remaining terminal, that is the other terminal. The other terminal receives the information and continuously searches the destination to perform a navigation service function (service function requested to the used terminal by the driver) when a navigation terminal is switched.

When the destination cannot be searched, it is signified that the destination is not searched although the driver inputs to search the destination. The navigation service cannot be executed when a route guide is too long, or the navigation service requested from the driver cannot be provided while a route is guided after the destination is found.

In addition, in the interworking procedure of the present disclosure, when the other terminal receives the route guide due to restrictions of a used terminal while the driver receives the route guide using the other terminal, the driver may switch and use the other terminal only by a simple operation in the used terminal.

For example, when the used terminal (terminal mounted in the vehicle) does not reflect real time traffic information, the used terminal is switched to the other terminal (smart device) to guide the route by reflecting real time traffic information. In this case, a terminal switch operation of the driver is achieved in the used terminal by a key operation (hard key or soft key operation), a voice input, or the like. If the switching is operated by the driver, the used terminal transmits necessary information such as destination information to the other terminal, so that the other terminal searches/sets the destination and generates/guides a running route.

When the switch of the terminal is operated, the information (information necessary to execute the navigation service) in the used terminal is automatically transmitted to the other terminal, so that the navigation service function may be performed without a separate driver operation (operations such as searching and setting the destination and a route guide request) in the other terminal. According to an exemplary embodiment of the present disclosure, when a driver inputs and searches a destination in the first terminal (onboard type terminal) 10, if there is no information searched from the first terminal 10, the first terminal 10 transmits destination information to the second terminal (offboard type terminal) 20 and then automatically terminates the navigation service. During this procedure, the first terminal 10 requests the communication-connected second terminal 20 to execute the navigation service before terminating the navigation service and transmits information necessary to execute the navigation service to the second terminal 20.

Accordingly, the second terminal 20 starts execution of the navigation service to automatically search the destination using the information provided from the first terminal 10, and automatically performs steps of setting the destination, and generating and guiding the running route using the search result.

However, even if the service of the first terminal 10 is terminated, display information of the second terminal 20 is transferred to the first terminal 10 when executing the second terminal 20 so that the display information of the second terminal 20 is equally displayed on a display device of the first terminal 10.

Although the foregoing embodiment has described that destination search and no search information in the first terminal 10, the service termination of the first terminal 10 and the destination search and route guide in the second terminal 20 are achieved, the same procedures may be performed in a state that functions of the first terminal 10 and the second terminal are exchanged with each other. That is, the operation may be achieved in the order of destination search and no search information in the second terminal 20, service termination of the second terminal 20, and destination search and route guide in the first terminal 10.

In the above description, as an example, when the destination search is impossible, the terminal is switched, but the present disclosure is limited thereto. When the used terminal cannot obtain desired information of the driver except for the destination information, for example, when the used terminal cannot obtain map information or Point of Interest (POI), the used terminal recognizes it to transfer requirements of the driver to another terminal through the communication so that another terminal, which receives the requirements of the driver, provides desired information to the driver, which may be included in a range of the present disclosure.

Referring to FIG. 5, when the first terminal (onboard terminal) 10 is used because a guide of the second terminal 20 is impossible due to network communication failure with a navigation server 30 outside the vehicle while the second terminal (offboard terminal) 20 receives a route guide after searching and setting the destination. Similar to FIG. 4, the first terminal 10 receives information for navigation execution from the second terminal, the navigation execution of the second terminal 20 is terminated, and navigation of the first terminal 10 automatically performs the destination search/set and generation/guide of the running route in the first terminal 10 according to the received information.

Before or after switching the terminal, even if a terminal is used, information is displayed on the display device (a head unit display device of an AVN system) mounted in the vehicle during running so that the route guide is achieved.

Further, in the above description, the destination information is described as information which may be transferred between terminals upon switch of the terminal, but the present disclosure is not limited thereto. That is, the information may include various information such as gateway information, POI, facilities search information, current location information, traffic information, search option information, avoidance zone information, map setting information, and navigation setting (vehicle type, oil type, guide, safety) information.

In addition, when a driver wants to switch to another terminal due to traffic congestion and the like and to receive a route guide, the driver may operate the terminal switch in a manual mode. In a state that the terminal is switched into the manual mode, as described above, a previous terminal transmits information to a terminal selected through an operation so that an information guide is continuously achieved.

Although the disclosure has been described in detail with reference to an exemplary embodiment thereof, it will be appreciated by those skilled in the art that the embodiment may be modified without departing from the principle and spirit of the disclosure, the scope of which is defined in the appended claims and their equivalents.

What is claimed is:

1. A method for interworking between navigation terminals, the method comprising: switching a used terminal in such a way that another terminal communication-connected with the used terminal receives information necessary to execute a navigation service to perform a navigation service function when the used terminal providing the navigation service mounted in the vehicle does not search a destination or does not execute the navigation service in a case where the terminals are mounted in the vehicle.

2. The method of claim 1, wherein the terminals comprise a navigation terminal mounted in the vehicle and a portable terminal in which a navigation application is installed.

3. The method of claim 2, wherein display information of the portable terminal is displayed on the navigation terminal mounted in the vehicle which is communication-connected with the portable terminal when the navigation service is executed.

4. The method of claim 1, wherein the terminals comprise an onboard terminal to provide the navigation service in an onboard scheme and an offboard terminal to provide the navigation service in an offboard scheme.

5. The method of claim 4, wherein when a failure in network communication with a navigation server outside the vehicle occurs when using the offboard terminal, the used terminal is switched in such a way that the offboard terminal transfers information necessary to execute the navigation service to the onboard terminal so that the onboard terminal performs the navigation service function.

6. The method of claim 1, wherein the used terminal is switched in such a way that the other terminal, which is communication-connected, receives the information necessary to execute the navigation service and performs the navigation service function when the used terminal is switched to the other terminal by a user.

7. The method of claim 1, wherein the used terminal, which does not search the destination or does not execute the navigation service, requests execution of the navigation service to the other terminal to transfer the information necessary to execute the navigation service to the other terminal.

8. The method of claim 1, wherein the information necessary to execute the navigation service comprises destination information to guide a running route, and the used terminal, which performs the navigation service function after the terminal switch, automatically searches and sets the destination and generates and guides the running route using the destination information.

9. The method of claim 4, wherein the information necessary to execute the navigation service comprises destination information to guide a running route, and the used terminal, which performs the navigation service function after the terminal switch, automatically searches and sets the destination and generates and guides the running route using the destination information.

10. The method of claim 6, wherein the information necessary to execute the navigation service comprises destination information to guide a running route, and the used terminal, which performs the navigation service function after the terminal switch, automatically searches and sets the destination and generates and guides the running route using the destination information.

11. The method of claim 7, wherein the information necessary to execute the navigation service comprises destination information to guide a running route, and the used terminal, which performs the navigation service function after the terminal switch, automatically searches and sets the destination and generates and guides the running route using the destination information.
